(19) United States
(12) Patent Application Publication
(10) Pub. No.: US 2020/0131038 A1
(43) Pub. Date: Apr. 30, 2020

(54) METHOD FOR EXTRACTING IODINE FROM AN AQUEOUS SOLUTION

(71) Applicants: Serguei TIKHONOV, Bremen (DE); Lia NEUMANN, The Woodlands, TX (US)

(72) Inventors: Serguei TIKHONOV, Bremen (DE); Lia NEUMANN, The Woodlands, TX (US); Yusub ISHANGULYYEV, Ashgabat (TM)

(21) Appl. No.: 16/662,511

(22) Filed: Oct. 24, 2019

(51) Int. Cl. C01B 7/14

(52) U.S. Cl. CPC C01B 7/14; B01J 20/041

(57) ABSTRACT

The present invention relates to a method for extracting iodine from an aqueous solution, the method comprising the steps: Providing an aqueous solution containing iodide ions; Heating the aqueous solution containing iodide ions; Adding an acid to the aqueous solution to arrive at a pH from 1.5 to 2.5; Adding an oxidizing agent to the aqueous solution to arrive at a Eₕ from 570 to 590 mV; Desorbing iodine by means of an airflow.

The present invention relates to a method for extracting iodine from an aqueous solution, in particular to a method of iodine extraction from drilling and formation waters of oil and gas fields by the air desorption method.

### BACKGROUND OF THE INVENTION

Elemental iodine or diatomic iodine (I₂) is a valuable chemical having many industrial and medicinal applications. There is an increasing demand for iodine and its major derivatives, iodide salts. The consumption of iodine and iodide salts is distributed among several industrial applications, such as catalysts, animal feed additives, stabilizers for nylon resins, inks and colorants, pharmaceuticals, disinfectants, film, and other uses. Much attention is therefore focused on the recovery of iodine from various sources, either as a primary product or as a by-product of other industrial processes.

Iodine has been isolated from gas well brine for a long time. The brine is pumped from a number of gas wells over many miles to a centralized processing facility. In that facility, the iodide rich brine is acidified and oxidized to obtain elemental iodine (I₂).

Methods for recovering iodine from brine using the air desorption method are well known in the art, for example from SU 1723028 A1; Ishangulyyev Y. I. Examining and modeling the process of iodine extraction from drilling waters by a method of air desorption, Abstract of PhD thesis, M.: Moscow Chemical and Technological Institute of D.I. Mendeleev, 1978. p. 17; or Ishangulyyev Y. I. Modeling and development of high-performance processes and installations for iodine and bromine extraction from drilling and associated waters of oil and gas fields using airflow method. Doctoral dissertation. M.: Russian Chemical-Technological University of D.I. Mendeleev, 1993. p. 447.

However, elemental iodine recovered in accordance with methods of the prior art often suffers from low purity and the yields of elemental iodine achieved by the methods of the prior art are rather poor.

It is therefore, the object of the present invention to provide a method for recovering iodine overcoming drawbacks of the prior art, in particular allowing recovery of iodine, in particular from byproducts of industrial processes, allowing to recover the elemental iodine in improved yields and with improved purity.

### DESCRIPTION OF THE INVENTION

The above object is achieved by the method for extracting iodine from an aqueous solution, the method comprising the steps:

Providing an aqueous solution containing iodide ions;

Heating the aqueous solution containing iodide ions;

Adding an acid to the aqueous solution to arrive at a pH from 1.5 to 2.5;

Adding an oxidizing agent to the aqueous solution to arrive at a Eₕ from 570 to 590 mV;

Desorbing iodine by means of an airflow.

In accordance with the invention it is provided that the above steps of the inventive method are carried out in the given order, i.e. a step mentioned after a foregoing step is carried out thereafter and a step mentioned before a subsequent step is carried out before. Each of the following steps is performed on a mixture obtained in the foregoing step if not explicitly mentioned else. The different process steps are performed using suitable equipment allowing to carry out the steps. Exemplary respective equipment is described with respect to the preferred embodiments and the detailed embodiment shown in the figures.

The prior art regarding chlorine iodine oxidation is quite extensive. In the majority of disclosures stock solutions were used which were significantly different from natural iodine-containing drilling and formation waters from oil and gas fields in their composition. Therefore, in industrial conditions, many of the recommendations and proposals of the prior art do not allow to achieve an optimal degree of iodine oxidation due to significant differences between the actual conditions of the iodine oxidation process using chlorine—which significantly affects the process of iodine extraction by air desorption method and reduces the efficiency of iodine extraction at this stage to 10-20%. This invention allows increasing the degree of iodine extraction at the stage of air desorption up to 95-97%.

The inventive method may further comprise, after the step of desorbing, one or more of the steps:

Adding a sorbent for chemisorbing the iodine;

Crystallizing the iodine;

Purifying the iodine under a layer of sulfuric acid;

Sublimation of the iodine.

### Providing the Aqueous Solution Containing Iodide Ions

The aqueous solution may further comprise a salt. In this regard, it may be preferred that the aqueous solution has a salinity from 10 to 400 mg/l.

The aqueous solution containing iodine ions may be brine. The term “aqueous brine” refers to any water-based solution or concentrated slurry of salt comprising iodide. Salts in aqueous brines consists chiefly of sodium chloride but may include other salts. Aqueous brines may be formed naturally as in the example of Oklahoma gas-brine wells and re-injection oil wells. Naturally occurring aqueous brines also occur in Japan and in California. Aqueous brines may also occur as seawater or concentrated seawater including seawater that occurs during or as a result of saltwater salination.

The aqueous solution containing iodide ions may be formation water or associated waters from oil and gas fields.

In this regard, formation water may be water in the undisturbed zone around a borehole. Although formation water normally is the same as geological formation water, or interstitial water, it may be different because of the influx of injection water.

The step of providing the aqueous solution containing iodide ions may comprise separating the aqueous solution from remaining oil particles and gas condensate.

The aqueous solution containing iodide-ions may comprise the iodide ions in an amount of at least 20 mg/l, alternatively 25 mg/l, alternatively 27 mg/l with respect to the total volume of the aqueous solution.

In the present application wherever it is referred to a “total amount”, “total volume” etc. it is referred to the amount, the volume etc. which is contained in the respective part of the equipment necessary to carry out the respective step and not to the total amount, total volume etc. contained in the entire equipment necessary to carry out all of the steps.

The formation iodine-containing water, which may have passed a series of settling tanks, where it may be separated from remaining oil particles and gas condensate, may be fed to a clarifier, where chemical reagents, coagulating pollution, may be added.

### Heating the Equation Solution Containing Iodide Ions

Heating the aqueous solution containing iodide ions may comprise heating to a temperature from 30 to 70° C., alternatively 40 to 60° C., alternatively 45 to 50° C.

The heating may be carried out using auxiliary heaters. In this regard, oil heaters may be preferred, in particular were associated petroleum or natural gas is used as gas for heating the iodide-containing water. Further preferred are electrical heaters which may also be used for heating the water.

The water, after being provided as mentioned above, may be fed to the auxiliary heaters, where it may be heated to a temperature of 45 to 50° C. and then may go to a horizontal cylindrical tank (sludge collector) which may be filled with a packing.

### Adding an Acid to the Aqueous Solution to Arrive at a pH Value from 1.5 to 2.5

The pH of the aqueous solution after adding the acid may be from 2.0 to 2.5.

The acid may be sulfuric acid and/or hydrochloric acid, preferably (the cheaper) sulfuric acid.

Adding the acid may be performed in a horizontal cylindrical hollow unit filled with a packaging (which may be “nozzle-shaped”, which may be a screw-like shape). In preferred embodiments, the packaging may be one or more selected from the group consisting of screw polyethylene (lined); screw-slotted polyethylene (lined); rashig rings (various sizes); screw 2-entry (equidistant); chord attachment; plane parallel packing; and other types of packings.

This packing can be a screw polyethylene mixer.

Initial associated oil water may have bicarbonate alkalinity. It may contain organic and inorganic substances that make it difficult to extract iodine. Before the formation water is fed for desorption (regeneration), it is acidified, for example with sulfuric acid (with addition of stock solutions) to pH 1.5 to 2.5, alternatively 2.0 to 2.5, which prevents iodine hydrolysis.

During the acidification process if sulfuric acid is used as the acid, the main reaction (1.) and secondary reactions (2.) and (3.) occur:

2NaI+H₂SO₄=2HI+NaSO₄ (1.)

Ca(HCO₃)₂+H₂SO₄=CaSO₄+2CO₂+2H₂O (2.)

2RCOONₐ+H₂SO₄=2RCOOH+Na₂SO₄ (3.)

During acidification, the pH of the formation water may be kept within the range of 2.0 to 2.5. Acidification of the formation water may be performed in a horizontal cylindrical hollow unit (sludge collector) filled with a packing (“nozzle-shaped”), in one of the ends of which the formation water and sulphuric acid are added.

Mixing of formation water with acid may occur in the process of their joint passing through the layer of packing (“nozzle-shaped”). Acidified water may be removed from the other end [of the unit] through a side fitting.

The carbon dioxide which may be produced by acidification may be removed and released into the atmosphere and the solid particles may be filtered (precipitate) by the packing. Such a scheme of acidification of drilling water allows an even performance of this process.

### Adding an Oxidizing Agent to the Aqueous Solution to Arrive at a Eₕ from 570 to 590 mV

The Eₕ is the redox potential and a measure of the degree of oxidation. The redox potential (also known as oxidation/reduction potential, ORP, pe, ε, or Eₐ is a measure of the tendency of a chemical species to acquire electrons from or lose electrons to an electrode and thereby be reduced or oxidized, respectively. Redox potential is measured in volts (V), or millivolts (mV). Each species has its own intrinsic redox potential; for example, the more positive the reduction potential (reduction potential is more often used due to general formalism in electrochemistry), the greater the species' affinity for electrons and tendency to be reduced.

In more detail, Eₕ is a measure of the redox (oxidation-reduction) state of a solution or, more exactly, its solutes. Eₕ is a measurement of electrical potential and thus commonly expressed in volts. Values of Eₕ in nature range from −0.6 to +0.9V, with o.o characterizing a solution with no drive to either oxidize or reduce.

The Eₕ value of the iodide-containing water may be measured by laboratory and industrial devices with external electrodes directly installed in flow cells with oxidized water.

The Eₕ after adding the oxidizing agent may be from 575 to 585 mV.

The oxidizing agent may chorine, chlorine water, nitrite, hypochlorite or mixtures thereof, preferably chlorine or chlorine water.

Adding the oxidizing agent to the aqueous solution may be carried out under stirring. The stirring may be carried out with a stirring speed of 100 to 300, alternatively 150 to 250 rpm, alternatively about 200 rpm.

In the step of adding the oxidizing agent air may be supplied to the aqueous solution. The air may be supplied in the amount of 1 to 3 m°/hour, alternatively 1.2 to 2 m°/hour, alternatively about 1.6 m°/hour.

### Desorbing Iodine by Means of an Airflow

The desorbing may be carried out in a vertical column apparatus filled with a desorber packing.

The vertical column apparatus may have a height from 10 to 20 m, alternatively 12 to 15 m.

The desorber packing may be filled into the vertical column apparatus with a height of 5 to 8 m, alternatively up to 7 m.

The vertical column apparatus may be made of titanium or fiberglass.

The temperature of the air flow may be influenced by the temperature of the heated water. In case that the iodide containing water is heated to a temperature from about 40 to 50° C., the air flow rate of the resorption or desorbing step may be decreased by 1.5 to 1.7 times.

The desorbing may be carried out with an airflow rate in the range 90 to 200, alternatively from 105 to 150 m³/m³, with respect to the total volume of the aqueous solution.

A water density of the desorber packing may be 20 to 80 m³/m²/hr, alternatively 40 to 60 m³/m²/hr, alternatively about 50 m³/m²/hr, with respect to the vertical column apparatus cross-section square.

The ratio of air of the airflow to the total amount of aqueous solution supplied to the desorber (G_{M}3/L_{M}3) depends on the temperature of the incoming water and may be from 85:1 to 150:1, in particular if the temperature of the aqueous solution is from 40 to 50° C.

The purpose of the desorption process is to regenerate the elementary iodine and may be carried out by means of an airflow in a vertical column apparatus (desorber) 12-15 meter high, made of titanium or fiberglass and filled up to 7 meters with a highly efficient packing.

The main indicator characterizing the efficiency of the iodine desorption process is the degree (%) of elementary iodine regeneration. The degree of iodine regeneration in the desorber depends on many factors: temperature of the heated formation water, [temperature of the] air, airflow rate, distribution of air and drilling water over the desorber section, type of packing, surface of the mass transfer (m²/m³) and the ratio of air to the amount of formation oil water supplied to the desorption column (G_{M}3/L_{M}3).

The water density of the desorber packing may be about 50 m3/m2/hr of the desorber cross-section square. Airflow rate for the desorption of elementary iodine in the column depends on the temperature provided to the desorber, [temperature of the] water and may be in the range from 105 to 150 m³/m³ of water.

This indicator depends on the coefficient of iodine distribution in the solution of drilling water, and is determined experimentally. The degree of desorption depends on the stage of iodine oxidation by chlorine and the mineralization of the formation water. The airflow rate should be directly proportional to the mineralization of the drilling water. The degree of iodine regeneration should be at least 95%.

The iodine gas mixture containing elementary iodine may be fed into the gas duct of an absorber to capture and bind elementary iodine. The desorption step may be considered most important one in the inventive method.

### Adding a Sorbent for Chemisorbing the Iodine

The sorbent may be sodium hydroxide and/or a mixture of iodine-hydrogen and sulfuric acid, preferably sodium hydroxide.

For example, a mixture of iodine-hydrogen and sulfuric acid may be obtained in the duct between the stripper and the absorber when sulfur dioxide (SO₂) is fed into the iodine-air mixture. In this case, the concentration of iodine sorbent may be 20 to 25 g/l. In cse that the sodium hydroxide is used as a sorber, a concentration in an amount of 80 to 120 g/l may be used.

The sorbent may be used in an amount of 50 to 200 g/dm³, alternatively 70 to 150 g/dm³, alternatively 80-120 g/dm³ with respect to the total volume of the aqueous solution.

As a sorbent for iodine binding, a solution of NaOH (sodium hydroxide) may be supplied to the absorber. In this case, the concentration of iodine in the sorbent may reach the value of 80-120 g/dm³.

At this stage the following chemical reaction of iodine binding may occur:

3I₂+6NaOH->5NaI+NaIO₃+3H₂O (8)

Additionally, carbon dioxide may partially be captured from a formation water during reaction and may be supplied along with the air during the desorption step of iodine in the desorber.

| | | | |
|---|---|---|---|
| 2 NaOH + CO₂ | → | Na₂CO₃ + H₂O | (9) |
| Na₂CO₃ + CO₂ + H₂O | → | 2 NaHCO₃ | (10) |

### Crystallizing the Iodine

The crystallizing may be carried out in a crystallizer.

When iodine is formed in the crystallizer, the following reactions may occur:

| | | | |
|---|---|---|---|
| 5 NaI + NaIO₃ + 3 H₂SO₄ | -> | 3 I₂ + 3 Na₂SO₄ + 3 H₂O | (11) |
| Na₂CO₃ + H₂SO₄ + Na₂CO₃ | -> | Na₄SO₄ + CO₂ + H₂O | (12) |
| 2 NaHCO₃ + H₂SO₄ | -> | Na₂SO₄ + 2CO₂ + H₂O | (13) |
| 2NaOH + H₂SO₄ | -> | Na₂SO₄ + 2H₂O | (14) |

The stock solution may be fed to the sorbent collector and a crystallizer from which iodine in the form of iodine paste with a iodine content of up to 85% is fed through a filter to a Vacuum Nutsche Filter.

### Purifying the Iodine Under a Layer of Sulfuric Acid

The purifying of the iodine under a layer of sulfuric acid may be carried out at a the temperature of 100 to 160° C., alternatively no to 150° C., alternatively 120-140° C.

The crystallized iodine may be transferred to a refining device under a layer of sulfuric acid. As a result of iodine refining in this device, iodine of AR grade (99.0%) is obtained or, in rare cases, of the LR grade (99.5%).

### Sublimation of the Iodine

Besides, the commercial appearance of the received crystalline iodine, in the form of pieces, may not correspond to the modern requirements of consumers (scaled) and therefore the prices for lump iodine pieces of mark AR are considerably lower than the prices for scaled iodine of mark LR on the world market. Therefore, crystallized iodine obtained on the melting machine under the layer of sulfuric acid may be fed to a sublimation-desublimation machine, which produces the scaled iodine of the LR grade.

The process of iodine sublimation is performed after the stage of its purification under a layer of sulfuric acid. In this case the iodine (85%) paste or the lump pieces of iodine (99.0) may be used as the initial iodine for loading into the sublimator, obtained in the iodine refining device under a layer of sulfuric acid.

Unlike iodine paste, where the moisture content is ˜15%, in crystallized (lump) iodine the moisture content may not exceed 0.8%, and therefore the process of sublimation and desublimation of iodine may be performed in one stage, which allows a twofold increase of capacity of the sublimation unit and producing of the scaled iodine, pharmacopoeia LR grade iodine with iodine content of 99.5 to 99.7%, in accordance with international standards.

### Packaging of the Finished Product

The inventive method may further comprise a last step of packaging the finished product in plastic containers.

### BRIEF DESCRIPTION OF THE DRAWINGS

FIG. 1 shows a laboratory setup for the study of kinetics of iodine oxidation in aqueous solutions.

FIG. 2 shows a reactor system for iodine oxidation in aqueous solutions on an industrial scale.

### DETAILED DESCRIPTION OF THE INVENTION

In the following, the present application will be described in detail with reference to the figure. It shall, however, be understood that not all of the preferred features mentioned in the following are necessarily needed for building an inventive device. Rather, one or more of the following preferred features may, separately or in combination, be used, in particular in combination with the above general disclosure of the invention, to realize the inventive method.

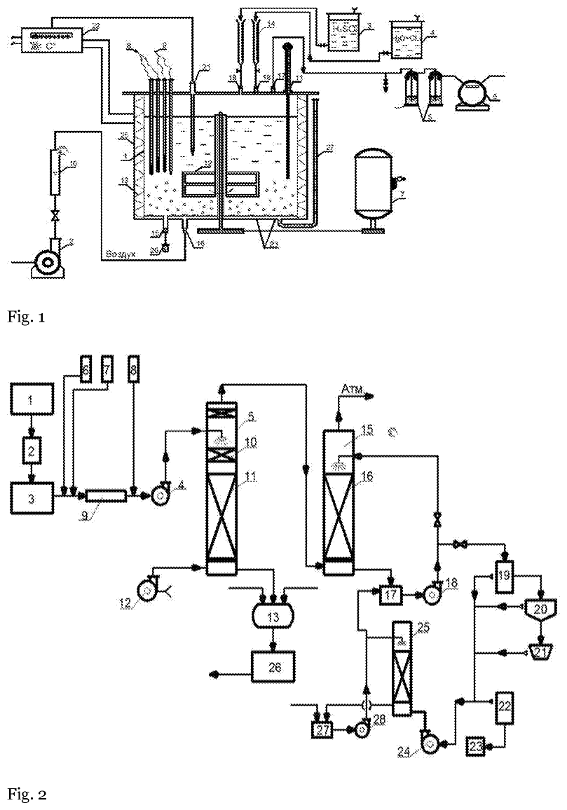

FIG. 1 shows a laboratory setup for the study of kinetics of iodine oxidation in aqueous solutions.

FIG. 2 shows a reactor system for iodine oxidation in aqueous solutions on an industrial scale.

The constituents of the laboratory setup shown in FIG. 1 are as follows:
1. reactor; 2. compressor; 3. sulfuric acid tank; 4. chlorine water tank; 5. drexel (vessel with absorber); 6. gas meter; 7. Electric engine with stirrer; 10. rotameter; 22. electronic temperature controller with thermal resistor.

Depending on the objective, research on the study of iodine oxidation kinetics by chlorine was conducted in three stages:
1. Study of iodine oxidation kinetics using chlorine at the temperature of the drilling water of 40° C., 45° C., 50° C.; pH=1.5; 2.0; 2.55; eH=540 to 560 mV; 575 to 585 mV;
595-615 mV without stirring or air supply.
2. At the same values of t ° C. of drilling water, pH, Eₕ of the solution—with stirring (at 200 rpm.).
3. At the same values of t ° C. of drilling water, pH, Eₕ of the solution—with stirring (at 200 rpm) and iodine regeneration through air in the amount of 1.6 m°/hour.

Experiments on the study of iodine oxidation kinetics in drilling water have shown that the process is significantly influenced by: pH of the environment, water temperature, the degree of oxidation (Eₕ), stirring and air supply.

The iodine oxidation process in drilling water has its own peculiarities. In salt-free solutions the change in temperature from 20 to 50° C. does not affect the degree of iodine oxidation while in the drilling water at the same degree of oxidation and pH of the environment the rate of iodine transfer from I₂ to I⁻ increases with the temperature increase from 45° C. to 50° C.

The acidity of the solution influences the kinetics of iodine oxidation as well. With the increase in acidity of the solution there was a decrease in the transfer rate of I₂ to I⁻. Comparison of the kinetic curves produced at pH 1.5 to 2.0 showed insignificant differences in the [transfer] rate and therefore in order to reduce the consumption of sulfuric acid used for acidification of the solution, the value of water acidity pH=2.0 to 2.5 should be considered optimal.

The studies on the influence of the amounts of oxidizer (chlorine) consumption in the process of iodine oxidation have shown that in the absence of an oxidizer (Eₕ=545 to 550 mV.) two forms of iodine (I₂ and I⁻) are formed in the solution, and after that, in result of the reaction, there is a sharp decrease in I₂ due to its transition to I⁻. As for the kinetic curves obtained at normal consumption of the oxidizer (Eₕ=575 to 585 mV.) it has been shown that at Eₕ=575 mV only I₂ is formed in the solution, that is, there is 100% [pure] I₂. Insignificant oversupply of chlorine water Eₕ=575 to 585 mV leads to the formation of I₂ and IO⁻³ at the percentage ratio of I₂=97 to 85% and IO⁻³=3 to 15%.

The IO⁻³ solution is then reduced to I₂ in 5-7 minutes, after which it is transitioned from I₂ to I⁻.

In case of significant overexposure of the oxidizer (Eₕ=595 to 615 mV), the process is similar to the previous one but the high amount of IO⁻³ of 32 to 35% formed in the process is transitioned completely to I₂ in time exceeding 30 minutes.

Studies to research the effect of stirring on the process of iodine oxidation have shown that the reducing IO⁻³ to I₂ occurs much faster in 2 to 3 minutes, and the formed IO⁻³ has enough time to transition in its entirety to I₂ and then to I⁻ in 30 minutes.

The study of the kinetic curves obtained by stirring the solution and regenerating I₂ from the solution showed that the removal of I₂ from the solution significantly accelerates the process of reduction of IO⁻³ to I₂ and its subsequent transition to I⁻. The duration of the reduction process of IO⁻³ to I₂ and the transition of I₂ to I⁻ takes from 13 to 15 minutes, meanwhile the same process takes more than 60 min in the homogeneous reactor. Thus, it can be assumed that the optimal value of Cl₂/2 I⁻ (provided that the amount of complex ions not involved in the interphase distribution is less than 10%): Cl₂=10%; I₂Cl⁻=55% and I⁻=30%. At the given composition I⁻ will influence the shift of equilibrium reaction ICl₂+I⁻ [symbol] I₂Cl⁻+Cl⁻ towards the formation of I₂Cl⁻, which easily dissociates to I₂ and Cl⁻.

On the basis of the received results it is considered expedient to carry out a step-by-step iodine ion oxidation that will necessitate structural changes in hardware setup of the desorber and maintaining of an exact dosage of chlorine in 3 points at the height of the packing. The results of studies on the hydrodynamics of the desorption process at semi-industrial and industrial plants have shown that the period of the liquid phase in the columns depends on the type of packing and hydrodynamic mode of operation of the column and ranges from 0.6 to 5 minutes. When the column operates in the emulsified mode or a similar one with a high-performance partially flooded packing, the time of the liquid phase in the column is 4-5 minutes. In this regard, the use of a highly effective iodine chemodesorption packing will bring the degree of iodine extraction at the stage of air desorption from 95 to 97%.

This [process] proposal follows from the fact that when chlorine is supplied to the solution in the amount corresponding to the value of pH=575 to 585 mV, from 3 to 15% of iodine is formed in the form of IO⁻³, which transitions to I₂ in 2 to 5 minutes. In this case, I₂ recovered from IO⁻³ will be regenerated by the air flow into the gaseous phase and by the time the entire IO⁻³ is transitioned to I₂ (at the bottom of the column) the remainder of I₂ will also be desorbed into the gas phase. This process does not require any changes in the design of the desorption unit and the introduction of an oxidizer at 3 points at the height of the packing, unlike step-by-step oxidation process. The data obtained from the laboratory setup shows that [the process of] iodine regeneration from the drilling water depends largely on pH, Eₕ and water temperature. The largest amount of desorbed iodine from drilling water was observed at pH=1.5 and Eₕ=585 to 605 mV.

This may be attributed the fact that the presence of iodine in the solution in large amounts of peroxidized IO⁻³ slows down the transition of I₂ to I⁻ until the entire IO⁻³ is reduced to I₂, which requires a significant amount of time. The amount of desorbed iodine in the gaseous phase would be much higher than it was recorded in the course of studies if the amount of air supplied to the process was more than 1.6 m³, which, in our opinion, is an insufficient amount.

The following conclusions can be made based on the results of the research:
1. The reaction of iodide oxidation in drilling water differs significantly from the reaction of iodide oxidation in non-saline solutions.
2. Iodide oxidation depends to a great extent on pH, Eₕ, temperature of drilling water and stirring;
3. It is established that the optimal parameters of the solution for iodide oxidation are: pH=2.0-2.5; Eₕ=575 to 585 mV;
4. It has been found that the higher degree of iodine desorption from drilling waters necessitates the previous stage of iodine oxidation;
5. For the purpose of full extraction of iodine from drilling and formation waters of oil and gas fields it is necessary to maintain the degree of iodine oxidation at a level that allows—at the moment when the oxidized drilling water enters the desorber—to have 3 to 7% of overoxidized iodine in the solution in the form of IO⁻³.
6. Optimal management of the iodine oxidation process depends in each case on the chemical composition of water, water temperature, type of packing and hydrodynamic mode of desorption.
7. It is found that the performance of the iodine oxidation process at an optimal level is possible through the introduction of a node enabling approximate and precise dosage of chlorine or chlorine-enriched water.

In the reactor system shown in FIG. 2 initial iodine-containing formation water (aqueous solution) is fed into separators of oil and water 1, where, after the separation of oil and solid impurities, it is supplied to the inlet of a water heater 2, where the aqueous solution is heated to a temperature of 45 to 50° C. and is pumped into a raw water tank 3.

Then the aqueous solution flows through a 1.5 m diameter fiberglass pipe—sludge collector 9 to a pump inlet 4 and afterwards to the top of a desorber 5 for irrigation of the desorber packing. Before the aqueous solution enters the desorber, the following parts are added to it: iodine stock solution from a tank 6, concentrated sulfuric acid for achieving a pH from 2.0 to 2.5, concentrated sulfuric acid, and chlorine water from an electrolyzer 8 for iodine oxidation.

Acidified and oxidized oil formation water containing iodine ions goes to the top of the desorber 5 and is evenly distributed over the active section of the column using irrigators. Flows of acidified and oxidized iodine-containing oil water flow down packings 10 and 11 while spreading into individual thin streams. An airflow is blown forming a counterflow from bottom to the top using a fan 12 with a speed of 1.7-1.85 m/sec against the water streams containing elementary iodine. In the course of this process takes place the desorption (transition) by air of elementary iodine from oil water into gaseous phase through the packing layer. The desorber 5 is a vertical cylindrical device made of titanium with an internal diameter of 2.0 to 3.4 m and a height of 12 to 15 m filled up to on two levels with heights 2 and 5 meters respectively with a highly effective packing.

The efficiency of the iodine desorption process depends on the specific surface of the packing used in the desorber, the temperature of the drilling water and the amount of air supplied for iodine blowing. Acidified and oxidized iodine-containing formation water is depleted from iodine as it flows down the packing, and the air supplied from the bottom to the top of the desorption column is enriched with iodine vapor as it rises to the top of the desorption column.

After iodine extraction, the spent acidified formation water is removed from the lower part of the desorption column through a hydrosealing device that prevents the air from escaping, and then goes to a unit 13 for its neutralization by alkaline solution from the electrolyzer 8 and by lime milk (calcium oxide—CaO) supplied to the neutralizing unit 13 until it reaches the value of pH=7.0 to 7.5. Afterwards, the treated and neutralized formation water is sent back to the plant for utilization of formation oil waters with further pumping of these waters into the absorbing horizons of oil wells.

The iodine/air mixture from the top of the desorber 5 flows through a duct 14 to the bottom of the absorber 15 and spreads in the process of its passing through the grate and packing 16, then it is directed to the upper part of the absorption column 15. Against the iodine-air mixture—from top to the bottom—adsorbent flows down (sodium-hydroxide solution) from the sorbent circulation tank 17, by means of a centrifugal pump 18 to the absorption column irrigator. Chemisorption processes take place on the surface of the packing between iodine and sodium hydroxide solutions. The design of the absorber is similar to that of the desorber and differs only in the height of the column—9 to 10 m and the height of the packing (5 m). As the sorbent flows down, the sorbent is enriched with iodine and iodate (the total iodine content), and the iodine gets extracted from the air as it rises up the column. After iodine has been extracted (captured) from it, the air escapes to the atmosphere through an exhaust pipe 19.

The sorbent solution is continuously circulating as per the following scheme:

K-15->E-17->K-15->E-17

As the iodine sorbent circulates, it is continuously enriched with iodine, i.e. the concentration of iodide I⁻ and iodate IO_{3 -} ions increases, and the content of sodium hydroxide accordingly decreases.

Lack of sodium hydroxide is compensated by the addition of a sorbent. For normal operation, the pH of the sorbent should be maintained within 9 to 11. After reaching the concentration of general iodine to 80-120 g/l, the basic part of a sorbent is gradually removed to the crystallizer 19 where the fresh water is continuously supplied from the tank for the purposes of cooling and rinsing.

When concentrated sulphuric acid and chlorine are continuously added from the tank 19, iodine paste gets extracted, which is fed to the Nutch Filter 20 and then sent to the iodine melting node under the layer of sulphuric acid 21 or to the iodine sublimator 22 and then for its package 23.

In order to reduce sulphuric acid consumption, the spent stock solution after the Nutch Filter 20 is fed to the stock solution receiving tank 6 and then added through the pipeline to iodine-containing water supply to the desorber 5. The iodine paste obtained through the filter is rinsed with the fresh water in the volume equal to the weight of the rinsed iodine (1 kg-1 liter of water) and then dried by suction of air through the iodine paste layer with a vacuum pump.

The refining device (iodine melter) 21 operates at a the temperature of 120 to 140° C. The temperature is maintained using four 1.5 kW heaters. Temperature control is maintained automatically using contact thermometers. Concentrated sulfuric acid and iodine paste are supplied from above. The acid is supplied from the pressure tank 7 with the force of gravity and the iodine paste is loaded manually.

Refined iodine is removed from the bottom of the unit through the packing, preventing the ingress of sulfuric acid into the finished product. Waste acid is removed from the side outlet and then used to acidify the initial water. Refined iodine is collected in the finished product collector units made of PTFE.

Iodine extracted to the collector units is then crushed and packaged per 50 kg into the drums with inserts made of polyethylene terephthalate film. The iodine is then fed into the unit 22 for the purpose of obtaining sublimated iodine and, after drying, is then fed to the packaging machines 23. The sublimated or technical iodine obtained shall conform the international standards in terms of its composition and package and shall be distributed in the following packages: 50 kg, 10 kg, 3 kg, 0.5 kg.

This technology of iodine production is modern, low-waste and ecologically safe. Waste acidic water from desorber is discharged to a reactor with a stirring device 13, into which the lime milk and alkali from the electrolyzer 8 are fed. Discharge water, after its neutralization with lime milk and alkali to pH 7.0 goes into waste water collector 26 and is then pumped into the waste oil formation water reservoirs.

In order to prevent harmful emissions of iodine vapor formed at the stages of crystallization, purification (sublimation) and scaling from escaping into the atmosphere, those emissions are driven by a fan 24 to the scrubbing packing 25 where the emissions are captured by a liquid absorber pumped 28 from the tank 27. The yield of the finished product (iodine of AR or LR) using this technology is 85 to 88%.

The features disclosed in the foregoing description, in the claims and the accompanying drawings may, both separately or in any combination, be material for realizing the invention in diverse forms thereof.

1. Method for extracting iodine from an aqueous solution, the method comprising the steps:
Providing an aqueous solution containing iodide ions;
Heating the aqueous solution containing iodide ions;
Adding an acid to the aqueous solution to arrive at a pH from 1.5 to 2.5;
Adding an oxidizing agent to the aqueous solution to arrive at a Eₕ from 570 to 590 mV; and
Desorbing iodine by means of an airflow.

2. Method according to claim 1 further comprising, after the step of desorbing, one or more of the steps:
Adding a sorbent for chemisorbing the iodine;
Crystallizing the iodine;
Purifying the iodine under a layer of sulfuric acid;
Sublimation of the iodine.

3. Method according to claim 1, wherein the aqueous solution containing iodide ions formation and associated waters from oil and gas fields.

4. Method according to claim 1, wherein the aqueous solution containing iodide-ions comprises the iodide ions in an amount of at least 20 mg/l with respect to the total aqueous solution.

5. Method according to claim 1, wherein heating the aqueous solution containing iodide ions comprises heating to a temperature from 30 to 70° C.

6. Method according to claim 1, wherein after adding the acid to the aqueous solution the pH is from 2.0 to 2.5.

7. Method according to claim 1, wherein the acid is sulfuric acid and/or hydrochloric acid.

8. Method according to claim 1, wherein the Eₕ after adding the oxidizing agent is from 575 to 585 mV.

9. Method according to claim 1, wherein the oxidizing agent is chorine or chlorine water.

10. Method according to claim 1, wherein adding the oxidizing agent to the aqueous solution is carried out under stirring.

11. Method according to claim 1, wherein in the step of adding the oxidizing agent, air is supplied to the aqueous solution.

12. Method according to claim 1, wherein the desorbing is carried out in a vertical column apparatus filled with a desorber packing.

13. Method according to claim 2, wherein the sorbent added for chemisorbing the iodine is sodium hydroxide.
